(19) United States
(12) Patent Application Publication
(10) Pub. No.: US 2004/0111666 A1
(43) Pub. Date: Jun. 10, 2004

(54) Software replicator functions for generating reports

(76) Inventor: James G. Hollcraft, Portland, OR (US)

Correspondence Address: STOEL RIVES LLP, 900 SW FIFTH AVENUE, SUITE 2600, PORTLAND, OR, 97204, US

(21) Appl. No.: 10/425,088

(22) Filed: Apr. 28, 2003

Related U.S. Application Data
(60) Provisional application No. 60/431,509, filed on Dec. 5, 2002.

(51) Int. Cl. G06F 15/00

(52) U.S. Cl. 715/503

(57) ABSTRACT

An improved system and methods for interactively designing and generating electronic reports, especially reports based on stored data. A reporting module is used in conjunction with an electronic spreadsheet program. The reporting module implements replicator functions. In a design mode of operation, the replicator functions present a simplified preview of the subject report. In transitioning to a report mode, each replicator expands the spreadsheet by automatically inserting copies of the replicator range, such a one or more rows or columns, in response to the data being presented in the final report. Thus the spreadsheet automatically “grows” as necessary to accommodate the actual data reflected in the final report, while preserving the general design of the report as previewed in the design mode. In the transition to the report mode, newly inserted elements are tagged for automatic removal during a switch back to the report mode.

### RELATED APPLICATIONS

This application claims priority from U.S. Provisional Application No. 60/431,509 filed Dec. 5, 2002 and incorporated herein by this reference.

### COMPUTER PROGRAM LISTING APPENDIX

A computer program listing appendix is submitted herewith on CD-R media as prescribed by 37 C.F.R. Sections 1.52 and 1.96, and is incorporated herein by this reference as though fully set forth. 37 C.F.R. 1.52(e)(5). A total of two identical compact discs are submitted, labeled “Copy 1” and “Copy 2”. Each disc contains a single text file named “ReplicatorFunctions.bas”. The file was created Apr. 23, 2003 and comprises 18,597 bytes (20,480 size on disc).

### COPYRIGHT NOTICE

© 2002-2003 Software Professionals, Inc. A portion of the disclosure of this patent document contains material which is subject to copyright protection, including without limitation the Computer Program Listing Appendix filed herewith on CD-R. The copyright owner has no objection to the facsimile reproduction by anyone of the patent document or the patent disclosure, as it appears in the Patent and Trademark Office patent file or records, but otherwise reserves all copyright rights whatsoever. 37 CFR § 1.71 (d).

### TECHNICAL FIELD

This invention pertains to reporting selected information from a data source and, more specifically, to designing and creating custom reports in an electronic spreadsheet, which may be connected to a data source.

### BACKGROUND OF THE INVENTION

Many powerful electronic databases and database technologies are known, including Oracle, Sybase, SQL Server, btrieve, just to name a few. And there are various query languages and technologies for retrieving desired data from databases. In general, retrieved data is used to form a report. Reports arrange, organize, manipulate and display data in a more meaningful or useful form than “raw data” simply retrieved from a data source. Electronic spreadsheet programs, Microsoft® Excel® for example (Microsoft Corporation, Redmond, Wash.), are popular reporting tools. Techniques are known for retrieving data from a database into a spreadsheet, and thus a spreadsheet can be used to create a report of such data. One example of a financial reporting software product is “F9” (a product of Synex Systems Corporation) which can be used to import data from an accounting system into a spreadsheet.

Existing report generating tools, however, are either too complex for average users or not powerful enough to generate desired reports. The present invention is directed to enhancing the spreadsheet model with powerful tools that are easy to use. These enhancements dramatically improve the productivity of users charged with creating spreadsheet types of reports based on retrieving selected data from a database.

Specifically, a report designer has a painstaking task to create a report that is well organized, and arranged to optimize ease of use. The designer may have to run the report on a small sample of data, adjust spacing, layout, and arrangement, and then try again with perhaps a larger data sample. This iterative process will work eventually but it is time consuming, and expensive in terms of computing resources.

Existing art for database access functions typically set the calculation mode to “Manual” because otherwise report design would be very slow. In the usual default (automatic) mode, all database access functions might be recalculated every time the content of a cell changes. Using manual recalculation mode, however, the user can't really see a sample of the report during the design process.

Moreover, database access functions are often problematic for spreadsheets because the spreadsheet can't tell when the underlying database has changed, and therefore it does not know when a database function should be recalculated. The common practice is to flag database functions as volatile, meaning that they need to be recalculated whenever anything else is calculated. Consequently, unless a manual calculation mode is used, the report designer must frequently wait for all the database access functions to recalculate every time any change is made to the spreadsheet.

There remains a need, therefore, to speed the report design and debug process. There is also a need to reduce the computing cost imposed by frequent database accesses and spreadsheet recalculations. Another problem in the prior art is that common data retrieval functions, as used, for example, in Microsoft® Excel® spreadsheets, employ a complicated, cumbersome syntax. Such formulas also slow the report design process.

### SUMMARY OF THE INVENTION

The present invention addresses these needs and in other ways improves upon the prior art of electronic spreadsheet report design and operation. Aspects of the present invention can be implemented in software as new functions for use in the formulas that define the desired contents of cells of a spreadsheet. As a simple example of the prior art, a spreadsheet cell might contain the formula “=44*ABS(E6)” This simple formula uses the mathematical functions multiply (*) and absolute value (ABS), both of which are well known and implemented in virtually all spreadsheet programs. The present invention includes powerful new functions to simplify spreadsheet report design and data retrieval.

One important feature of the invention is a series of novel “replicator functions”. A “replicator function” preferably is implemented in software, either within or in association with an otherwise generally conventional electronic spreadsheet program, such as the Excel® spreadsheet program. For example, a replicator function can be implemented in the Visual Basic language, or a variant thereof, for execution within Excel. The invention is not limited, however, to any particular implementation, implementation language, target spreadsheet or data source. The program listing submitted herewith is merely illustrative and not intended to limit the scope of any claim.

The replicator function is generally used to expand a spreadsheet to accommodate desired report data as needed, automatically and dynamically. For example, a “row replicator” can be used to automatically add one or more rows to a report for each data item or record. Similarly, a “column replicator” can be used to automatically add one or more columns per selected data item. Replicators relieve the report designer of the burden of determining the number of items in a data set in order to properly size the report. And the designer need not revisit the report design as the number of items in the data set changes; the replicator functions take care of that automatically. Replicator functions are easy to use, yet powerful enough to generate most reports. They provide a simple building block for a report designer. When multiple replicators are combined or nested, complex reports can be generated very easily. Essentially, the spreadsheet report automatically “grows” (by automatic insertion of rows, columns, sheets, even workbooks) responsive to retrieved data, as a result of just one, or a very few, replicator functions (called the “original replicators”), as further explained below. (Original replicators are those inserted by the designer. Additional replicators can be created automatically as a result of “expanding” the original replicators as further explained later. Thus, one aspect of the invention can be described as a computer program for use in conjunction with an electronic spreadsheet program; the program including code for finding an original replicator function in a cell of a spreadsheet, and additional code for modifying the spreadsheet by expanding the original replicator function.

One specific example of a replicator described further below is called “CopyRows( )”. Although the name can be arbitrary, this name conveniently implies that it is a row replicator. A Computer Program Listing Appendix that implements the “CopyRows( )” replicator function is submitted herewith and incorporated as part of this specification. The program in the appendix is based on a current commercial embodiment of the invention, but has been substantially simplified to better describe the invention without superfluous details, many of which are merely speed optimizations.

Another aspect of the invention is a reporting module for use in conjunction with a spreadsheet application program. The reporting module, in one embodiment, implements replicator functions, and provides for distinct Design and Report modes of operation. Full recalculation of the spreadsheet (report) is triggered only upon entering the Report Mode. Further, special database access functions are provided during the Design mode as further explained later.

In accordance with the invention, the Design mode is used to design or “program” a desired report. Here, functions, formulae and the like are entered into the cells of a spreadsheet, largely as in the prior art. In design mode, however, only a preview of the ultimate report format is displayed. Thus, during the design mode of operation, the spreadsheet exhibits a simplified, relatively terse appearance, that defines the data to be reported, but displays only a sample of the actual values or data. The design mode facilitates designing a desired report, using special functions such as replicators. FIG. 7 shows a sample report in the design mode.

Report mode is akin to execution of the spreadsheet. It involves automatic replication of certain ranges of the spreadsheet (as required by the replicators), retrieval of data from a data source if specified, filtering that data, calculating and filling in cell contents, etc. The switch to report mode (after some delay for data retrieval and recalculation of cell contents) results in display of the final report, with all necessary data retrieved and cell values calculated. The report can then be saved, printed, e-mailed, etc. It can also be “exported” without disclosing the underlying design of the report.

In Report Mode, both the original elements (rows, columns etc.) and copies exist. A switch back to Design mode, in a presently preferred embodiment, triggers automatic removal of the copies of rows, columns, etc. that were created by execution of original replicators. Thus the simpler, terse design display is restored to facilitate revision of the design if needed.

Additional aspects of the invention are directed to data retrieval. As noted above, various functions are known for data retrieval. However, data retrieval functions can be simplified, and therefore report design made easier and faster, by improved data retrieval functions described herein. One example of an improved data retrieval function is called =NF, one use of which is illustrated in FIG. 4.

Additional aspects and advantages of this invention will be apparent from the following detailed description of preferred embodiments, which proceeds with reference to the accompanying drawings.

### BRIEF DESCRIPTION OF THE DRAWINGS

FIG. 1 is a simplified block diagram of a computer coupled to a data source to store and retrieve data, as is well known.

FIG. 2 is a simplified software block diagram illustrating use of a reporting module in connection with an electronic spreadsheet application to generate a report based on data retrieved from a database in accordance with the present invention.

FIG. 3 is a partial display screen-shot illustrating a pull-down menu of one embodiment of a reporting module integrated into an electronic spreadsheet application for generating reports in accordance with the present invention.

FIG. 4 is a sample spreadsheet display showing one example of a replicate function (or simply, “replicator”) and two additional data retrieval functions (=NF), in accordance with aspects of the present invention.

FIG. 5 is a sample spreadsheet display showing the spreadsheet of FIG. 4 in report mode; the data (names and phone numbers) having been retrieved and inserted automatically into the spreadsheet by employing features of the present invention.

FIG. 6 shows the underlying formulas and all hidden cells from the spreadsheet of FIG. 5.

FIG. 7 is a spreadsheet screen display showing a sample report in design mode of operation and showing the formulas used to create the report employing features of the present invention with different replicator and data retrieval functions.

FIG. 8 is the same worksheet as shown in FIG. 7 but here displayed in the report mode of operation.

FIG. 9A is a simplified flow diagram illustrating a process of transitioning to report mode in accordance with one embodiment of the present invention.

FIG. 9B is a simplified flow diagram showing the “expand” step of FIG. 9A in greater detail, again accordance with one embodiment of the present invention.

FIG. 10A is a partial screen display of a spreadsheet report shown in the design mode of operation.

FIG. 10B shows the report of FIG. 10A after transition to the report mode.

FIG. 11A is a partial screen display of a spreadsheet report shown in the design mode of operation and including nested replicator functions.

FIG. 11B shows the report of FIG. 11A after transition to the report mode.

### DETAILED DESCRIPTION OF PREFERRED EMBODIMENTS

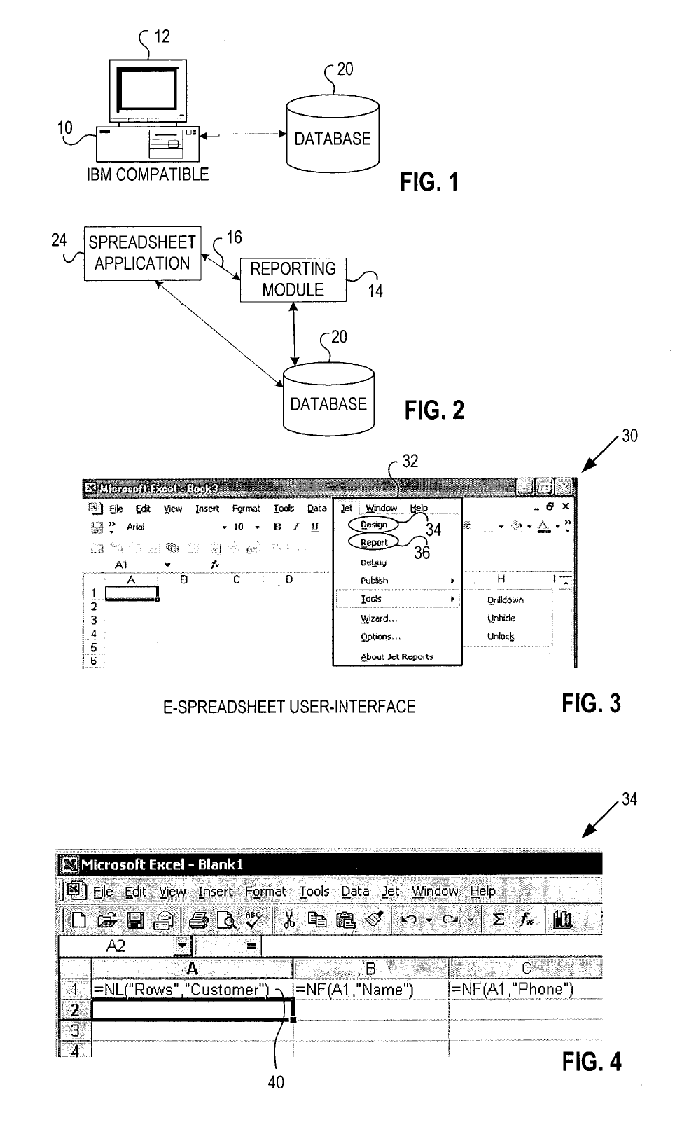

FIG. 1 is a simplified diagram of a computer 10 and attached monitor 12 having access to a database or other data source 20. The computer 10 or the like may be a standalone machine, but commonly will be coupled to a network, either wired or wireless. The “computer” need not be a desktop or even a laptop model; it could take the form of a portable or personal digital device, suitably configured.

Referring now to FIG. 2, software executable on the computer 10 of FIG. 1 includes an electronic spreadsheet application program 24, such as Microsoft® Excel® or the like, for the creation of reports based on data stored in the database 20. This much is well known in prior art and accordingly details are omitted.

The illustrative software of FIG. 2 further includes a “reporting module” 14, as further described herein, which can be integrated into, or arranged to operate interactively with, the spreadsheet application program 24 to provide enhanced reporting functionality in accordance with the present invention. In one presently preferred embodiment the reporting module is implemented as an Excel add-in, indicated by connection 16. As illustrated, the reporting module can access the database 20.

FIG. 3 is a partial screen display illustrating a user interface 30 of an electronic spreadsheet program, namely Excel, including a pull-down menu 32. This illustrates one embodiment of a reporting module integrated into the spreadsheet in accordance selected features of the invention. The pull-down menu 32, labeled “Jet” (referring to Jet Reports®, a commercial product that implements features of the present invention), includes menu items “Design” 34, “Report” 36, etc. The Design menu item 34 switches the reporting module to the Design mode of operation mentioned above for designing a desired report. Conversely, the Report menu item 36 switches the reporting module to the Report mode of operation mentioned above for generating and displaying the report. Thus FIG. 3 illustrates an example of a user interface of the reporting module, integrated into the Excel user interface. Any other convenient means can be used for the user to switch modes, for example a button click, keyboard entry or voice command.

First we assume the spreadsheet is in the Design mode. A report designer or user types formulas into selected cells as is conventional. The designer can include a replicator in a desired location on the spreadsheet. Replicators can include a row replicator, column replicator, worksheet replicator and even workbook replicator. One example of a replicator function is called the =NL function. A replicator function preferably implements a syntax that includes at least three elements: a name, a range extent, and a list of values. In one embodiment, which is Excel® spreadsheet compatible, the range and list of values are input as parameters following the name.

The name given a replicator is arbitrary, except that it may be used to imply the extent. For example, the name “Copy2Rows” might be the name of a replicator, implying that the extent is two rows. We use “range” herein to mean a portion of a spreadsheet, including at least the cell containing the replicator function and additional cells as specified by the extent of the replicator, typically entire rows, columns or sheets. The extent of a replicator is analogous to the shape and size of the range. For example, the extent of a replicator might indicate one or more rows (a “row replicator”) or columns, or an entire worksheet.

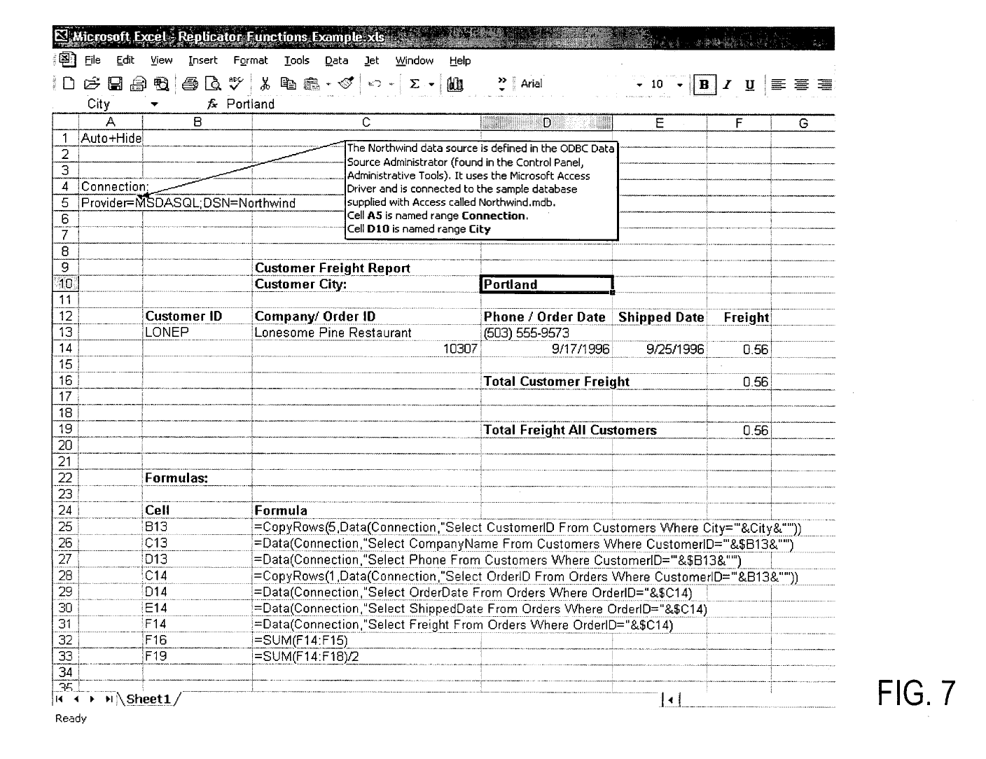

The particular syntax of a replicator is not critical. In a presently preferred embodiment, the replicator conveniently employs the same general syntax as is used for other functions in the target spreadsheet program. For example, in Excel, a formula is indicated by the leading equal sign (=), followed by the function name, followed by arguments enclosed in parentheses. A comma separates each argument. An example of a replicator function employing a similar syntax would employ the form: “=Replicator_Name (extent, list of values)”. For example: =CopyRows(5, Data(Connection, “Select CustomerID From Customers Where City=′″&City&″”)). Here, the extent is 5 rows and the list of values is provided by the specified data function. (This type of list is used in the report of FIG. 7, described later.)

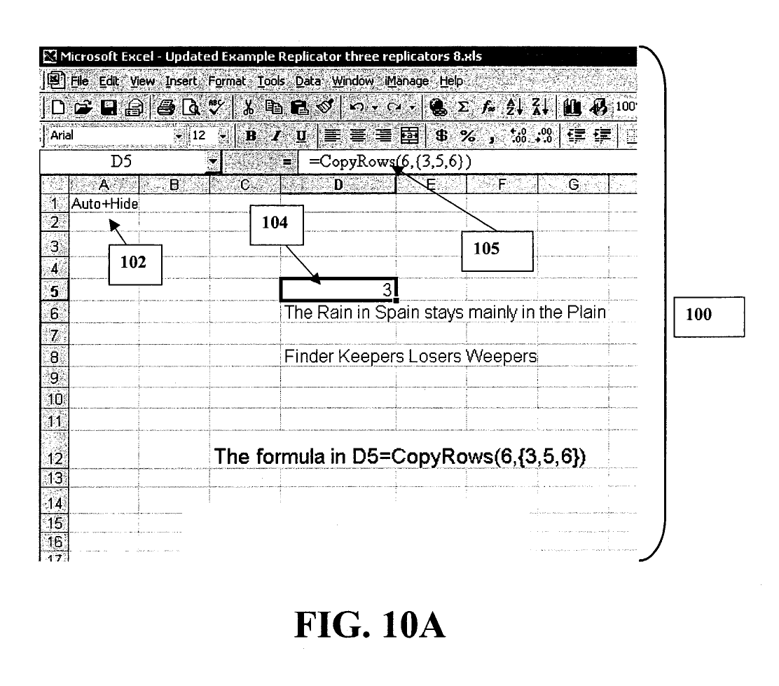

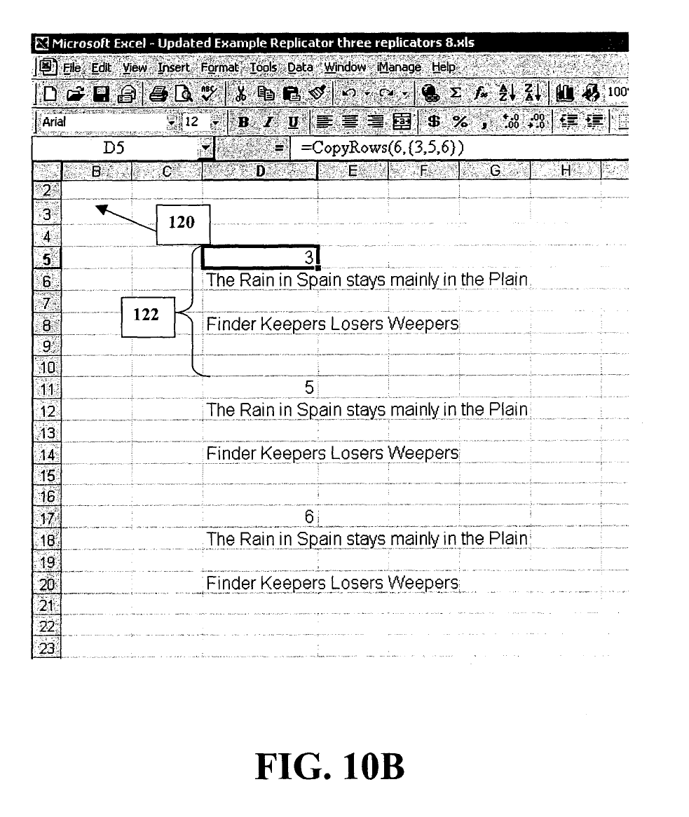

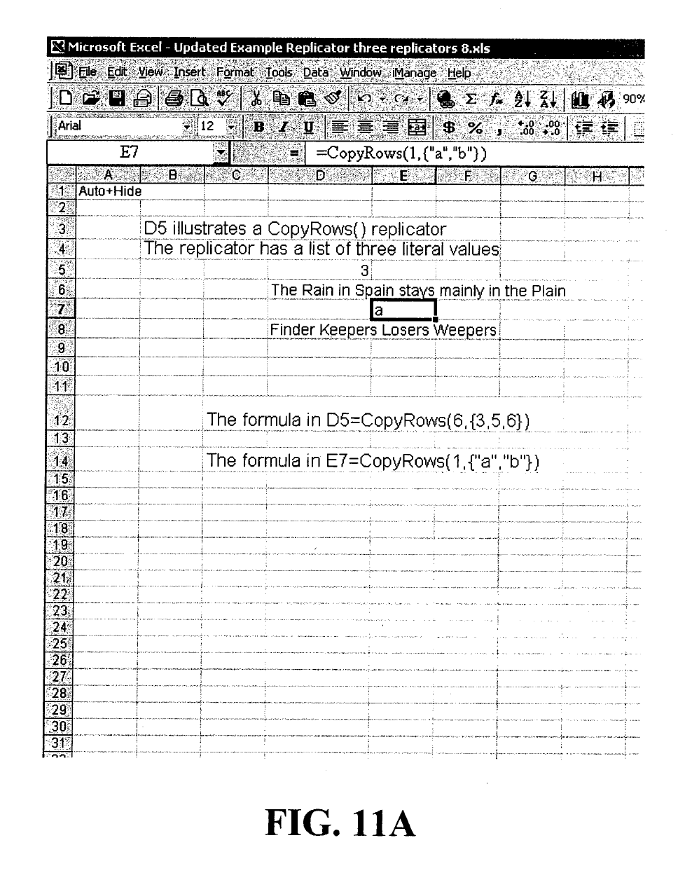

Another example of a replicator function is as follows: =CopyRows (6, {3,5,6}). This replicator has an extent of six rows (the first argument in the parentheses). When it is “expanded,” it will insert copies of the row in which it is located, together with the next five rows, between its row and the next row. Referring now to FIG. 10A, a partial screen display 100 of a simple spreadsheet report is shown in the design mode of operation. The indicia 102 in cell A1 serve to mark row 1 as automatic, and to mark column 1 as hidden.

Reference 104 points out cell D5 which contains the replicator. The selected cell formula, in this case the replicator function, is displayed in the formula window 105. We also see sample text in cell D6 (“The Rain in Spain . . . ”) and cell D8 (“Finders Keepers . . . ”). In this example, the data list consists of literal values; no external data source retrieval is required. Note that a sample one of the replicator list of values {3,5,6}, here the first value “3”, appears in the replicator cell during design mode. By returning a sample value to the replicator cell (for example, the first value of its data list, though it need not necessarily be that one), it provides a preview of the final report appearance.

FIG. 10B shows the spreadsheet report of FIG. 10A after expansion, in other words, after transition to the “report mode”. In FIG. 10B, note at 120 that row 1 is removed and column A is hidden. Brace 122 indicates the cell D5 replicator range of six rows. In rows 11-16, we see that a copy of that range has been inserted into the report. The second replicator data value “5” is returned in the copied replicator cell at D11. Another copy of the range is inserted at rows 17-22. Once again, the sample text is duplicated (along with the blank rows), and this time the third replicator data value “6” is returned into the copied replicator cell at D17.

The “list of values” or “data list” specified as an argument in a replicator function can be almost anything, e.g. an Excel array of literal values, other cell references, or a set of values retrieved from a database. For data retrieval (from a database), the “list of values” would be a data set, defined typically by a connection, a table, a field name, filter or criterion, etc. The retrieval function returns the number of records that satisfy the request, and the replicator expands the spreadsheet to accommodate the data by inserting the replicator range [range] for each such record.

FIG. 4 is another screen-shot 34 illustrating a replicator function 40 shown in cell A1. This replicator function is called NL (the name is arbitrary), using Excel-type syntax: =NL(“Rows=1”,“Customer”). This example is a replicator with an extent of one row. It specifies that a single row, the row in which the NL function is placed, is to be copied for customer records in the data table. In other words, if the target data source table (say, part of database 20 in FIG. 1) has 25 customers, for example, the =NL function will copy (replicate) the entire row in which it appears, here row 1, 24 times, inserting the new rows below the original. For the first customer, the original replicator space is used. New rows are inserted below the original row. The respective data from each record is inserted in the corresponding row.

As noted earlier, we refer to the “range” of the replicator as the spreadsheet area or range that will be copied for elements in its list of values, typically values in the database table of interest. The range can be one or more rows, one or more columns, one or more sheets, and so on theoretically without limit with respect to hierarchical levels of a spreadsheet-like program. Examples are shown in Table 1:

| REPLICATOR FUNCTION | EXTENT | PER EACH. . . |
|---|---|---|
| =NL(“Rows=1”,“Customer”) | One row | Customer record |
| =NL(“Rows=3”,“Vendor”) | Three rows | Vendor record |
| =NL(Columns=2″,“Month”) | Two columns | Month |
| =NL(“Sheets=1”,“State”) | One sheet | State |

In operation (that is, upon switching to report mode), the first replicator in the table above will add (insert) one row into the spreadsheet report for each customer record beyond the first one in a list of customer records further explained below. Typically, a list is formed by accessing a data source specified in the replicator (for example, a database of customers). The replicator causes replication of its “range” (for example, two rows, or a column, or five rows) for items in the list. We refer to this as “expanding” the replicator. The number of replicated “ranges” is one less than the number of elements in the list of values, as the first value is returned by the original replicator. Then the value of the second and each additional item on the list replaces the replicator function in the corresponding copy. Details are illustrated in the sample computer program listing appendix.

The particular syntax of a replicator function is not critical; it can be selected by the implementing programmer. It is convenient and therefore preferred to use a syntax consistent with the target spreadsheet program. In Excel, for example, formulas begin with a leading equal sign (=), so too replicator functions preferably begin with the equal sign.

A replicator can employ a syntax along the following lines: =replicator_name(arguments). Typically, the arguments comprise a “range” extent and a data set or list of values as shown above. For example, =NL(“rows=1”, “customer”) This replicator provides one row for each element in a data set (table) named “customer”. In operation, for n elements in the data set, the report module will insert n-1 copies of the replicator following the original replicator location. For example, a row replicator will insert rows below the original replicator row, and fill in each inserted row with a copy of the original replicator row. The cell corresponding to the original replicator function in each new row will contain an element of the list of values.

Report Mode

In transitioning to the report mode, as noted above, the replicator (or more precisely, replicator implementation software) inserts a copy of its range for values in its list of values. In the previous example, in report mode, the entire row would be copied for each Customer. The entire row, column, or other range of the replicator is copied in the presently preferred embodiment. However, this is not essential is all cases; a partial row or other unit could be copied.

Continuing the present example, the formulas in the spreadsheet after replication would appear similar to the illustration in FIG. 6. Referring now to FIG. 6, column B, rows 5 thru 7 contain the 2nd thru 5th values returned by the NL(“Rows=1”,“Customer”) function. These values returned by the function in B4, are used by the NF function to return the Name and Phone number of each customer. The “Auto” (automatic) tags in column A identify the rows inserted automatically by the replicator function. These are used to identify and remove the automatic (replicated) rows upon switching from report mode to design mode as further explained below.

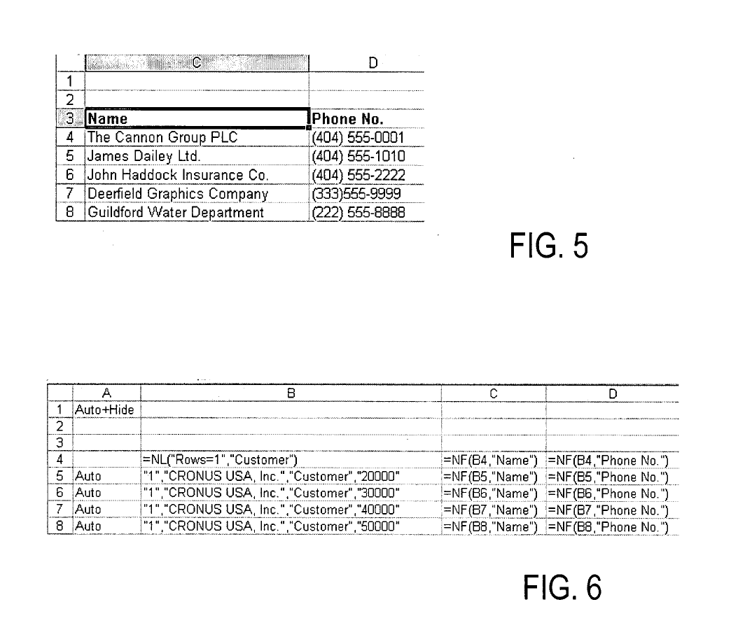

The resulting report would appear generally as shown in FIG. 5. Here, columns A and B are hidden, and column titles have been added. The actual data values are immaterial; this illustration is to show the layout of the report and operation of the replicator function. For the user, a simple menu selection or button changes modes from Design to Report and from Report to Design, as described above with reference to FIG. 2. In switching to Design mode, all the copied (replicated) ranges are deleted leaving only the original replicators. In Report mode, copies are created by the replicators.

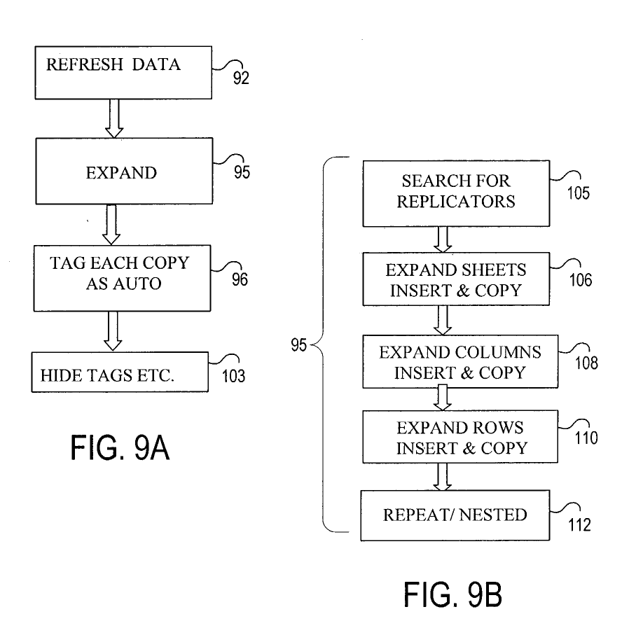

These processes are illustrated in the flow diagram of FIG. 9A. In FIG. 9A, an illustrative process of transitioning from design mode to report mode is shown. Refresh data, step 92, includes accessing the appropriate database to update data values, if necessary.

Next the report process calls for expanding the replicators, step 95. Step 95 is illustrated in greater detail in FIG. 9B. In FIG. 9B, the expand process comprises searching for replicators, step 105; and, responsive to the replicators, expanding worksheets and even whole workbooks if indicated. This is done by insert and copy operations 106.

Next the columns are expanded, if appropriate, step 108, again by insert and copy operations, as indicated in the replicator parameters. And finally, the rows are expanded as needed, step 110, as indicated by the replicators and their parameters as explained above.

These expand operations may be nested and repeated as indicated by step 112. A top-down hierarchical expansion as illustrated is preferred. Replicators may be nested, meaning that one replicator may be placed within the range of another replicator. The outer replicator is expanded first and in the process, makes copies of the inner replicators. Then each of the inner replicators are expanded. A simple example to further illustrate nesting is described below.

Referring again to FIG. 9A, after expanding the replicators (including any nested or “in-line” replicators), in step 95, the process calls for tagging each copy of the replicator elements as auto, step 96. The actual tag or name used is not critical. The purpose is to tag all automatically-generated cells to facilitate removing them when switching back to design mode. The tags are hidden when the final report is displayed in report mode, step 103.

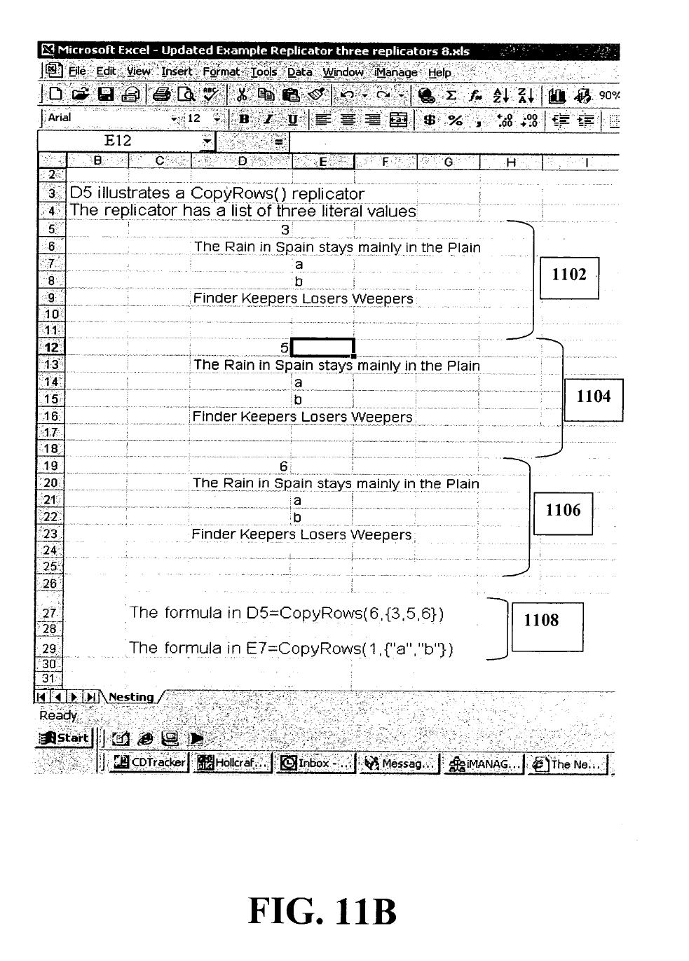

FIG. 11A is a partial screen display of a spreadsheet report shown in the design mode of operation. Cell D5 has a replicator function =CopyRows(4,{3,5,6}). In cell D5 in the display, the first data value “3” appears as a preview. Sample text strings are set forth in cells D6 and D8. Cell E7 also has a replicator function =CopyRows(1,{“a”,“b”}). Thus it has an extent of one row, and two literal values. Note that the first value “a” appears in the cell E7.

FIG. 11B shows the report of FIG. 11A after transition to the report mode. Several features can be observed here. First, column A and row 1 are hidden in this mode in this example. The first replicator is expanded by inserting two copies of its range. The original replicator range was six rows. However, the expanded range is seven rows, as indicated by reference number 1102 in FIG. 11B. Copies of the replicator range appear at 1104 and 1106. Each copy includes a copy of the original replicator of E7, and each copy returns the next value on the data list (see cells D12, D19).

Each copy of the first replicator range expanded by a row due to expansion of the inner replicators as follows. Each instance of the E7 replicator (i.e., the original plus the two copies created by the D5 replicator) returns the value “a” in the location corresponding to the original replicator (E7, E14, E21). Each instance of the E7 replicator also inserts a second row immediately following the replicator, and there returns the second literal value “b” (cells E8, E15, E22). The text at reference number 1108 (rows 27-29) is that which appeared at rows 12-14 in the design mode of operation shown in FIG. 11A. This text was effectively pushed down by some 15 rows as a consequence of expanding the replicators.

Design Mode Aware Database Functions return the quickest possible result in Design Mode even if a different result would be returned in Report Mode. For example, in Report Mode, a sort of thousands of records might be required to determine the first item in the list. In Design Mode, the function would return any item in the list instead of doing the sort.

Formula Shorthand [=NF]

Spreadsheet users are accustomed to writing a formula into a cell that will point to or retrieve a specific data element. However, the traditional way of retrieving data from a database is to request multiple fields at a time, or even whole records. The value of each field is to be inserted into a corresponding cell, but the spreadsheet works on the basis of individual cells, each having its own formula. This forces users to write a complete data retrieval function for each cell, typically specifying in a data function a query, for example an SQL query, comprising a table, a condition and a value. For example, in FIG. 7, see the formula for D13: =Data(Connection, “select phone from customers where customerID=“&$B13&””)

This type of data retrieval formula is cumbersome. Another aspect of the present invention provides a formula shorthand function, arbitrarily called =NF. Before executing =NF, a first function returns a special value. This special value could require many function arguments to determine. Once the special value is returned in a spreadsheet cell, a second function references that cell as one argument, and adds one or more additional arguments to return another value. The second function does not need to repeat all the arguments in the first function. This second function is referred to herein as the =NF function.

To illustrate, the first function could return a record pointer or key. The second function could return a field from the record. There might be 10 arguments needed to determine the record key. The second function might only need two arguments. If multiple fields were desired, the complexity of the functions could be reduced significantly. In this case, Formula Shorthand would allow a report designer to concisely select multiple fields from a record while maintaining the familiar formula based spreadsheet model.

Use of the Optional NF Function

The =NL replicator function also returns a special value—or key—that can be used by other functions to return additional fields from the record. For example, to create a simple customer phone list, the following functions could be entered in the spreadsheet in one row (here, the embedded colons indicate the boundaries of cells or columns):

=NL(“Rows=1”,“Customer”):=NF(B3, “Name”):=NF(B3, “Phone No.”).

The foregoing example illustrates use of the NL function explained above, to replicate one row for each customer record. The contents of the row that contains the NL function will be duplicated into each new (replicated) row. The example also introduces a data function NF which is used to fill in data in the report mode. The NF function above retrieves the contents of the specified field from the customer record each time it occurs. So the first instance will retrieve the “Name” field from the current customer record, and the second instance will retrieve the “Phone No.” field contents from the same customer record. Note that the NF data function references the cell containing the replicator (here “B3”) to determine a current record. In FIG. 4, the NF functions reference cell A1 which contains the row replicator that will create a new row for each record.

When a replicator is placed into Report mode, copies of the replicator's range are inserted into the spreadsheet if the replicator's list of values contains more than one item. The copies are inserted directly after the replicator's range. In the copies, the replicator function is replaced with values from the list: the second value goes in the first copy; the third value goes in the second copy, and so on. The process of inserting copies of a replicator's range is also known as expanding the replicator.

When two replicators have the same range, generally the first replicator to be expanded is the one above or the one to the left (or to the right perhaps in languages read right to left). The sequence of expansion should be consistent with the definition of “after” used to determine where replicator copies are inserted.

When the replicator is placed into Design mode, all copies are deleted and only the original ranges remain. To make moving from Design Mode to Report Mode easier, range copies should be tagged so they can be quickly deleted.

FIG. 7 shows an example of a worksheet in the Design mode. In that worksheet, the Auto+Hide tag appears in cell “A1” as discussed above. Cells “A4” and “A5” define a data source. DSN (data source name) “Northwind” is a data source defined in the ODBC Data Source Administrator (found in Windows Control Panel, Administrative Tools). It uses the Microsoft Access® Driver and is connected to the sample database supplied with Access called Northwind.mdb.

Further, in FIG. 7, cell “A5” is a named range Connection and cell “D10” is named range City. The lower part of the figure, from row 22, displays the formulas in each of the pertinent cells of this report design. The functions shown include =CopyRows, =Data, and =SUM (which is a standard Excel function). This implementation illustrates that replicator functions like =NL, can be both a replicator and a data-retrieval function. Here, the two functions are separated; “Copyrows” is a pure replicator and “Data” is a data retrieval function. These functions can be implemented as an alternative embodiment of the invention while providing advantages quite similar to those of the combined replicator (=NL) described earlier.

Referring to FIG. 7, it should be noted that several types of functions are illustrated, including “CopyRows” and “Data” functions. “CopyRows” illustrates a replicator function used to “expand” the report. Referring to row 25 in the drawing, the formula for cell B13 used this function. The arguments include the number of rows to replicate (5) for each item in the list. The “list” of items here employs the Data function which, in turn, specifies a connection and a query, as illustrated.

Specifically, the formula in row 25 illustrates one possible syntax for a replicator function (here CopyRows). It has arguments extent (5), and a data retrieval function that provides a list of data values, in this example customer ID numbers for customers in the City=Portland.

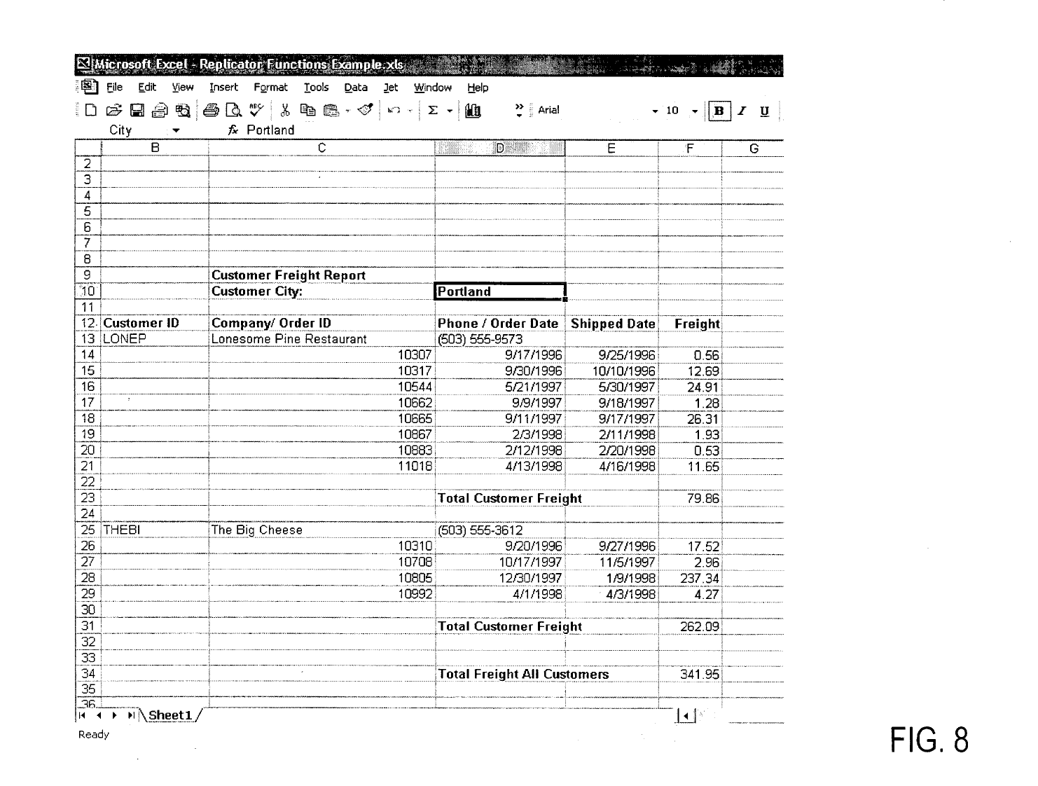

FIG. 8 shows the worksheet of FIG. 7 in the Report mode. Several observations are pertinent. First, column A is hidden, which serves to hide the data source connection information. The replicator function of cell B13 has expanded by inserting a copy of its range for the second customer (ID=“THEBI”). (Only two customers meet the retrieval criteria in this example.) Note that the original replicator range of five rows, rows 13-17, provided space for (1) the customer information, (2) at least one order, and (3) a total customer freight charge (cell F16). Blank rows (15,17) before and after the total customer freight charge improve readability of the report. Accordingly, before expanding the C14 replicator for each individual order, each customer had a range of five rows.

Next the C14 original replicator, and a copy of it in the second customer range, each expanded to accommodate the orders returned, in other words the corresponding data list. For the first customer (Lonesome Pine Restaurant), the first order was returned in the replicator location C14. Then copies of that replicator row were inserted for each additional order, into rows 15-21 of FIG. 8. In each row, the indicated data retrieval functions returned the specified field values, namely order date, shipped date and freight charge. Similarly, within the second customer range, the order replicator inserted three new rows. The final report of FIG. 8 thus presents the data in a neat and organized fashion, resulting from just two replicator functions, combined with the appropriate data retrieval functions.

The program provided in the computer program listing appendix illustrates one implementation of spreadsheet replicator functions, including entering report mode and returning to design mode. The replicator function in the code example is CopyRows( ). The program listing is a simplified version of a replicator function implementation; some optimizations, more sophisticated string parsing, and some error checks are omitted to simplify the code and facilitate understanding of the replication process. This example is in the Visual Basic language and is designed for use in Microsoft Excel®.

The same general pattern as described above applies when replicating columns, sheets, or entire workbooks. It is also possible to pass “what to copy” as a function argument instead of having explicit functions for each type of replication. These and many other variations on the general principles taught herein will be apparent to those skilled in the art in view of this disclosure, including the sample code listing below.

It will be obvious to those having skill in the art that many changes may be made to the details of the above-described embodiments without departing from the underlying principles of the invention. The scope of the present invention should, therefore, be determined only by the claims set forth below.

1. A computer program stored on machine readable media for use in conjunction with an electronic spreadsheet program, the program comprising:
first instructions for finding an original replicator function in a cell of a spreadsheet compatible with the electronic spreadsheet program; and
second instructions for modifying the spreadsheet by expanding the original replicator function.

2. A computer program according to claim 1 wherein the said second instructions modify the spreadsheet during a transition from a first state of the spreadsheet to a second state of the spreadsheet.

3. A computer program according to claim 2 wherein said expanding the original replicator function includes:
determining a range of the original replicator function;
identifying an ordered list of data items associated with the original replicator function;
returning a first data item in the list as the original replicator function result;
for each item in the list beyond the first item, inserting into the spreadsheet a copy of the original replicator range; and
in each such copy, replacing the replicator with a corresponding one of the data items in the list.

4. A computer program according to claim 3 wherein the first copy is inserted at a location immediately after the original replicator and each additional copy is inserted immediately following the last inserted copy so as to form a sequence of copies.

5. A computer program according to claim 3 wherein the computer program is implemented as an add-in to the electronic spreadsheet program.

6. A computer program according to claim 3 wherein the ordered list of data items is returned by a data retrieval function that accesses an external data source.

7. A computer program according to claim 3 wherein the ordered list of data items includes at least one literal value.

8. A computer program according to claim 3 wherein the ordered list of data items includes a reference to at least one cell in the spreadsheet.

9. A computer program according to claim 3 wherein the original replicator function has an extent equal to at least one row.

10. A computer program according to claim 3 wherein the original replicator function has an extent equal to at least one column.

11. A computer program according to claim 2 and further comprising third instructions for modifying the spreadsheet so as to return it to the first state.

12. A computer program according to claim 11 wherein the third instructions automatically remove from the spreadsheet all cells that were inserted into the spreadsheet during the transition from the first state to the second state.

13. A replicator function for use in an electronic spreadsheet file stored on a computer-readable media for specifying selected aspects of a design of the spreadsheet, the replicator function comprising:
first indicia for indicating an extent of the replicator function, the extent comprising a size and a shape of the replicator function; and
second indicia for identifying data for insertion into cells of the spreadsheet upon a transition of the spreadsheet from a design state to a report state.

14. A replicator function according to claim 13 wherein the replicator function has a name that implies one or both of the shape and size of the extent.

15. A replicator function according to claim 13 and wherein the data is identified by a data retrieval function.

16. A replicator function according to claim 13 and wherein the data comprise a reference to at least one cell in a spreadsheet.

17. A replicator function according to claim 13 and wherein the data values comprise at least one literal value.

18. A replicator function according to claim 13 and wherein the extent is at least one row.

19. A replicator function according to claim 13 and wherein the extent is at least one column.

20. A replicator function according to claim 13 and wherein the extent is at least one sheet.

21. A method for generating a report in an electronic spreadsheet program, the method comprising the steps of:
providing a design mode of operation of the electronic spreadsheet program and a report mode of operation of the electronic spreadsheet program;
opening an electronic spreadsheet in the electronic spreadsheet program;
providing a predetermined user input for switching between the design mode and the report mode; and
responsive to switching to the report mode of operation, refreshing the spreadsheet data, said refreshing step including:
detecting an original replicator function in a formula of a cell in the spreadsheet; and
expanding the detected original replicator function.

22. A method for generating a report according to claim 21 and further comprising, in the design mode of operation, displaying a sample data value in the cell where the original replicator function was detected, thereby providing a preview of a final report as it will appear in the electronic spreadsheet in the report mode of operation of the electronic spreadsheet program.

23. A method for generating a report according to claim 21 wherein said expanding the original replicator function includes:
determining a range of the original replicator function;
identifying an ordered list of data items associated with the original replicator function;
returning the first item on the list as the original replicator function result; and
for each item in the list beyond the first item, inserting into the spreadsheet a copy of the original replicator range; and in each such copy, replacing the replicator with a corresponding one of the data items in the list.

24. A method for generating a report according to claim 23 wherein said ordered list of data items includes a data retrieval function to access a data source outside of the spreadsheet.

25. A method for generating a report according to claim 23 wherein said ordered list of data items includes at least one literal value.

26. A method for generating a report according to claim 23 and further comprising, responsive to switching to the design mode of operation, deleting each copy of the original replicator range that was inserted into the spreadsheet upon switching to the report mode of operation.

27. A method for generating a report according to claim 23 and further comprising, responsive to switching to the design mode of operation, deleting the cells comprising each copy of the replicator range that was inserted into the spreadsheet.

28. A method for generating a report according to claim 23 and further comprising:
tagging the cells comprising each copy of the replicator range inserted into the spreadsheet; and
responsive to switching to the design mode of operation, searching for such tagged cells, and deleting the tagged cells.

29. A method for generating a report according to claim 23 and further comprising automatically hiding selected cells of the electronic spreadsheet upon switching to the report mode of operation.

30. A method for generating a report according to claim 29 and further comprising automatically unhiding the selected cells of the electronic spreadsheet upon switching to the design mode of operation.

31. An integrated reporting system comprising software stored on machine-readable media and executable on a digital computer, the software system comprising:
an electronic spreadsheet program, the electronic spreadsheet program having a spreadsheet interface;
a reporting module user-interface integrated into the spreadsheet program user-interface for user interaction while a user is using the spreadsheet; and
a reporting module providing for switching between a design mode of operation of the electronic spreadsheet program and a report mode of operation of the electronic spreadsheet program in response to user input via the reporting module user-interface;
wherein said switching to the report mode of operation includes searching for and expanding an original replicator function found in a cell of a spreadsheet open in the electronic spreadsheet program.

32. An integrated software reporting system according to claim 31 wherein the reporting module user interface implements said mode switching responsive to any one or more of a pull-down menu operation, a predetermined keyboard operation and a button click on the user interface display.
